(19) United States
(12) Patent Application Publication
(10) Pub. No.: US 2022/0314913 A1
(43) Pub. Date: Oct. 6, 2022

(54) VEHICLE STRUCTURE AND BRACKET FOR VEHICLE

(71) Applicants: TOYOTA JIDOSHA KABUSHIKI KAISHA, Aichi-ken (JP); SUBARU CORPORATION, Tokyo (JP)

(72) Inventors: Hitoshi AOYAMA, Toyota-shi (JP); Dan SUZUKI, Tokyo (JP); Takeshi NUMATA, Tokyo (JP)

(21) Appl. No.: 17/686,315

(22) Filed: Mar. 3, 2022

(30) Foreign Application Priority Data
Apr. 2, 2021 (JP) 2021-063458

(51) Int. Cl. B60R 19/48; B60R 19/50; B60R 19/24; B60Q 1/00; B60R 11/00; G01S 13/931

(52) U.S. Cl. CPC B60R 19/483; B60R 19/50; B60R 19/24; B60Q 1/0023; B60R 11/00; G01S 13/931; B60R 2019/505; G01S 2013/93272; G01S 2013/93277; G01S 2013/93275

(57) ABSTRACT

A vehicle structure includes a body, a bracket provided on the body, a bumper cover attached to the bracket, and an object detection device attached to the bracket.

### CROSS-REFERENCE TO RELATED APPLICATION

This application claims priority to Japanese Patent Application No. 2021-063458 filed on Apr. 2, 2021, incorporated herein by reference in its entirety.

### BACKGROUND

### 1. Technical Field

The technology disclosed in the present specification relates to a vehicle structure.

### 2. Description of Related Art

An object detection device that detects objects (e.g., pedestrians, other vehicles, buildings, and so forth) that are present in the surroundings of a vehicle has been developed. Japanese Unexamined Patent Application Publication No. 2017-215186 (JP 2017-215186 A) discloses a technology for attaching a radar device, which is an example of an object detection device, to a dedicated bracket provided on a body of the vehicle.

### SUMMARY

In the technology of JP 2017-215186 A, an object detection device is fixed to a body of a vehicle via a dedicated bracket, and accordingly there is a problem in that a greater number of parts is needed.

A vehicle structure according to a first aspect of the disclosure includes a body, a bracket provided on the body, a bumper cover attached to the bracket, and an object detection device attached to the bracket

In the vehicle structure according to the above aspect, the object detection device may be a radar device that is disposed facing a part of the body through which radio waves are transmitted, the radar device being configured to transmit and receive the radio waves through the part of the body.

In the vehicle structure according to the above aspect, the bumper cover may be a rear bumper cover.

The vehicle structure according to the above aspect may further include a rear combination lamp attached to the body, and a lamp garnish disposed below the rear combination lamp. The object detection device may be a radar device that is disposed facing the lamp garnish, the radar device being configured to transmit and receive radio waves through the lamp garnish.

In the vehicle structure according to the above aspect, the lamp garnish may be fixed to the bumper cover.

In the vehicle structure according to the above aspect, the object detection device may be disposed closer to a vehicle cabin than the bumper cover is, and a space may be provided between the object detection device and the bumper cover.

According to a second aspect of the disclosure, a bracket for a vehicle includes a bumper cover attaching portion that attaches a bumper cover to a vehicle body, and an object detection device attaching portion to which an object detection device is attached.

In the above-described vehicle structure, both the bumper cover and the object detection device are attached to the bracket in common. That is to say, the bracket serves as a bracket for attaching the bumper cover as well as a bracket for attaching the object detection device. Thus, the above-described vehicle structure can attach the object detection device to the vehicle while an increase in the number of parts is restrained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle structure of a rear portion of a vehicle; and

FIG. 2 is a cross-sectional view of the vehicle structure in the rear portion of the vehicle, including a body, a bracket, a radar device, a bumper cover, and a rear combination lamp.

### DETAILED DESCRIPTION OF EMBODIMENTS

An embodiment of a vehicle structure disclosed in the present specification may include a body, a bracket provided to the body, a bumper cover attached to the bracket, and an object detection device attached to the bracket. The bumper cover may be a front bumper cover provided at a front end of a vehicle, or a rear bumper cover provided at a rear end of the vehicle. It is sufficient as long as the object detection device is capable of detecting objects (e.g., pedestrians, other vehicles, buildings, and so forth) that are present in the surroundings of the vehicle, and the type of the object detection device is not limited in particular. In one example, the object detection device may be a radar device that detects positions of objects present in the surroundings of the vehicle using radio waves.

When the bumper cover is the rear bumper cover, the vehicle structure of the above embodiment may further include a rear combination lamp attached to the body, and a lamp garnish disposed below the rear combination lamp. In this case, the object detection device may be a radar device that is disposed facing the lamp garnish, and that is configured to transmit and receive radio waves through the lamp garnish. According to this vehicle structure, even when the rear bumper cover is painted metallic, for example, the radar device can transmit and receive radio waves through the lamp garnish, and accordingly the radio waves are not absorbed or scattered by the rear bumper cover. Thus, the strength of the radio waves is not attenuated very much, and accordingly the radar device can detect objects well. In this embodiment, the object detection device is disposed facing the lamp garnish, but this configuration is not limiting. Depending on requirements, the object detection device may be attached to any position of the bracket, for example in accordance with the height of the vehicle body.

In the vehicle structure of the above embodiment, the lamp garnish may be fixed to the bumper cover.

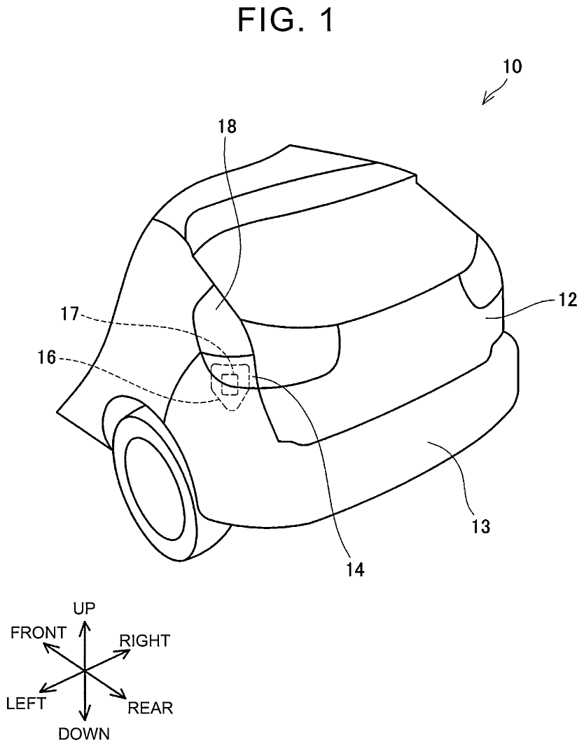

As illustrated in FIG. 1, the vehicle structure 10 includes a hatch 12, a rear bumper cover 13, a lamp garnish 14, a bracket 16, a radar device 17, and a rear combination lamp 18. Note that the radar device 17 is an example of an object detection device.

The hatch 12 is disposed at the rear portion of the vehicle and is attached to a body making up a vehicle framework, so as to be capable of pivoting in an up-down direction on a hinge (omitted from illustration). The rear portion of the vehicle is opened and closed off by the pivoting of the hatch 12.

The rear bumper cover 13 is disposed at the rear end of the vehicle and is attached via the bracket 16 to the body making up the vehicle framework, which will be described later. The part of the bracket 16 to which the rear bumper cover 13 is attached is a bumper cover attaching portion. The rear bumper cover 13 extends along a vehicle width direction, below the hatch 12. The rear bumper cover 13 may be made of resin, for example, although not limited in particular. The rear bumper cover 13 is painted the same color as the entire vehicle, or may be painted with metallic paint containing bright material (e.g., aluminum flakes), although not limited in particular.

The lamp garnish 14 is fixed to an upper edge of the rear bumper cover 13. Accordingly, the lamp garnish 14 is disposed below the rear combination lamp 18 when the rear bumper cover 13 is attached to the bracket 16, and makes up part of a lamp design continuing from the rear combination lamp 18. The lamp garnish 14 may be made of resin, for example, although not limited in particular. The lamp garnish 14 is configured such that radio waves are transmitted and received by the radar device 17 through the lamp garnish 14, and is painted opaque (e.g., black). The lamp garnish 14 is not painted metallic, so that radio waves are transmitted and received by the radar device 17 through the lamp garnish 14.

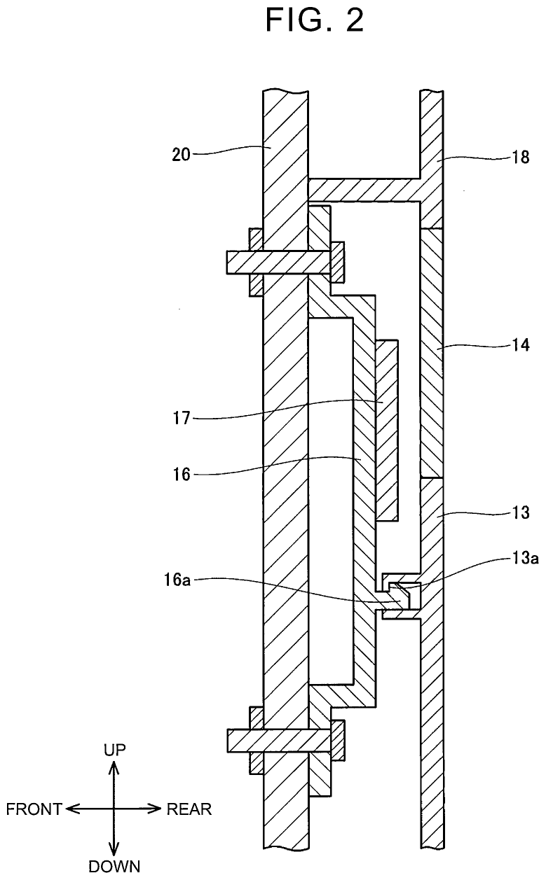

As illustrated in FIG. 2, the bracket 16 is fixed by a fastener (e.g., a bolt or the like) to a body 20 making up the vehicle framework. The bracket 16 may have a fixing claw 16a, for example, although not limited in particular. In this example, the rear bumper cover 13 is fixed to the body 20 via the bracket 16, by fitting the fixing claw 16a of the bracket 16 into a fitting hole 13a provided in a back face of the rear bumper cover 13. The fixing claw 16a of the bracket 16 is an example of a bumper cover attaching portion.

The radar device 17 is a device for detecting objects (e.g., pedestrians, other vehicles, buildings, and so forth) that are present rearward of the vehicle. The radar device 17 may be configured to radiate millimeter waveband radio waves, receive the radio waves reflected by objects present within a range of radiating, and calculate positions of objects based on the time from transmitting the radio waves to reception thereof, and so forth, for example, although not limited in particular.

The portion at which the radar device 17 is attached to the bracket 16 is an object detection device attaching portion. The radar device 17 may be attached to the bracket 16 via an engaging member (omitted from illustration), for example, although not limited in particular. The radar device 17 is disposed facing the lamp garnish 14 in a vehicle front-rear direction. Accordingly, radio waves transmitted and received by the radar device 17 can transmit through the lamp garnish 14.

The rear combination lamp 18 is fixed to the body 20 making up the framework of the vehicle, via the fastener (omitted from illustration). In FIG. 2, only a lamp cover making up the rear combination lamp 18 is illustrated, and a light source and so forth are omitted from illustration. The lamp cover making up the rear combination lamp 18 may be made of resin, for example, although not limited in particular. As described above, the rear combination lamp 18 is disposed above the lamp garnish 14 and is disposed continuing from the lamp garnish 14. The rear combination lamp 18 is configured so that light from the light source does not reach the lamp garnish 14. Accordingly, the lamp garnish 14 does not have a light-emitting function.

As described above, the radar device 17 is attached to the bracket 16 to which the rear bumper cover 13 is attached. That is to say, the bracket 16 serves as a bracket for attaching the rear bumper cover 13 and a bracket for attaching the radar device 17. Thus, in the vehicle structure 10, the radar device 17 can be attached to the vehicle while an increase in the number of parts is restrained.

Further, the radar device 17 is disposed facing the lamp garnish 14, and is configured to transmit and receive radio waves through the lamp garnish 14. Accordingly, even when the rear bumper cover 13 is painted metallic, for example, the radio waves transmitted and received by the radar device 17 are neither absorbed nor scattered by the rear bumper cover 13, and thus the strength of the radio waves is not greatly attenuated. Also, in another embodiment, the radar device 17 may be disposed facing a part of the body through which radio waves are transmitted, and the radar device 17 may be configured to transmit and receive radio waves through this part of the body.

Further, due to the radar device 17 being attached to the bracket 16, the radar device 17 is disposed forward in the front-rear direction of the vehicle from the rear bumper cover 13, and a space is formed between the radar device 17 and the rear bumper cover 13. Accordingly, even when the rear bumper cover 13 is damaged due to a collision or the like, damage to the radar device 17 can be suppressed. Also, in another embodiment, when the bumper cover is a front bumper cover, the radar device 17 is attached to the bracket 16, so that the radar device 17 is disposed backward in the front-rear direction of the vehicle from the front bumper cover, and a space is formed between the radar device 17 and the front bumper cover. Accordingly, even when the front bumper cover is damaged due to a collision or the like, damage to the radar device 17 can be suppressed. In other words, the object detection device is disposed closer to the vehicle cabin side than the bumper cover is, and a space is provided between the object detection device and the bumper cover.

Although specific examples of the technology disclosed in the present specification are described in detail above, these are only exemplifications, and are not intended to limit the scope of the claims. The technology described in the claims includes various modifications and alternations of the specific examples exemplified above. The technical elements described in the present specification or the drawings exhibit technical utility alone or in various combinations, and are not limited to the combinations described in the claims as originally filed. The technology exemplified in the present specification or the drawings can achieve a plurality of objects at the same time, and has technical utility in itself by achieving one of the objects.

What is claimed is:

1. A vehicle structure, comprising:
a body;
a bracket provided on the body;
a bumper cover attached to the bracket; and
an object detection device attached to the bracket.

2. The vehicle structure according to claim 1, wherein the object detection device is a radar device that is disposed facing a part of the body through which radio waves are transmitted, the radar device being configured to transmit and receive the radio waves through the part of the body.

3. The vehicle structure according to claim 1, wherein the bumper cover is a rear bumper cover.

4. The vehicle structure according to claim 3, further comprising:
a rear combination lamp attached to the body; and
a lamp garnish disposed below the rear combination lamp,
wherein the object detection device is a radar device that is disposed facing the lamp garnish, the radar device being configured to transmit and receive radio waves through the lamp garnish.

5. The vehicle structure according to claim 4, wherein the lamp garnish is fixed to the bumper cover.

6. The vehicle structure according to claim 1, wherein the object detection device is disposed closer to a vehicle cabin than the bumper cover is, and a space is provided between the object detection device and the bumper cover.

7. A bracket for a vehicle, the bracket comprising:
a bumper cover attaching portion that attaches a bumper cover to a vehicle body; and
an object detection device attaching portion to which an object detection device is attached.
